(19) United States
(12) Patent Application Publication
(10) Pub. No.: US 2005/0060209 A1
(43) Pub. Date: Mar. 17, 2005

(54) Method and system for insuring longer than expected lifetime

(76) Inventors: Charles Frederick Hill, Wyndmoor, PA (US); Pippa Catherine Hill-Strathy, Wyndmoor, PA (US)

Correspondence Address: RATNERPRESTIA, P O BOX 980, VALLEY FORGE, PA, 19482-0980, US

(21) Appl. No.: 10/962,837

(22) Filed: Oct. 12, 2004

(30) Foreign Application Priority Data
Jul. 22, 2003 (WO) PCT/US03/22734

(51) Int. Cl. G06F 17/60

(52) U.S. Cl. 705/4

(57) ABSTRACT

A computer based method and system to provide insurance protection to compensate an interested party against the financial risk that an elderly person (the “Insured”) lives a longer than expected lifetime. The method comprises the steps of determining a target survival date for the insured; determining a survival benefit; receiving a premium in exchange for payment of the survival benefit to a survival-beneficiary upon survival of the insured to the target survival date; and paying the survival benefit to the survival-beneficiary based on the insured surviving to the target survival date.

This application claims priority to International Patent Application No. PCT/US03/22734, filed on Jul. 22, 2003.

### FIELD OF THE INVENTION

The present invention relates to methods and systems for providing insurance to interested parties on elderly persons to protect against the risk of the elderly person living a longer than expected lifetime, more specifically, to determining and providing a single lump sum benefit that is payable at a predetermined time in the future should the insured elderly person survive to the predetermined date.

### BACKGROUND OF THE INVENTION

Numerous studies have demonstrated the long-term trend of higher and higher life expectancy in all of the world's major populations. These studies have demonstrated increased life expectancy not only at birth, but also in the retirement years, ages 55 plus. The improvements at these older ages have been a result of improvements in diet and lifestyle, medical detection, treatment and prevention as well as general improvements in socio-economic well being in most major economies. This trend of increased life expectancy is expected to continue in the future for all the same reasons. Furthermore, dramatic advances in medicine resulting from the human genome projects may significantly accelerate this rate of mortality improvement. As a result, the probability of living to age 100 and beyond and potentially outliving one's financial resources will increase significantly.

Other studies have shown that in most of the major economies of the world, populations are aging dramatically. As the baby boom generation enters its retirement years there will be a considerable increase in demand for investment products that produce retirement income and offer protection against the risk of outliving one's financial assets.

During the last two decades, individual investors have become much more comfortable with allocating more of their investment dollars into equity and higher risk/higher return products. The current asset allocation mantra of the capital markets is that stocks will outperform bonds in the long run. Today's future retirees have taken a long-term view and over the last 10 years have increased their allocation in equity investments from 20% to nearly 60%. As a result, fixed rate products such as annuities have become out-of-favor with investors as well as the brokers and financial planners who advise investors. While this effect has mitigated somewhat since the equity market began declining in March of 2000, studies show that investors continue to allocate over 50% of their investments into equity oriented assets. As a result, there is lower demand today by investors for fixed rate retirement income products such as fixed-rate retirement income products including annuities. While there is still interest and demand for the longevity insurance protection offered by annuities, investors are reluctant to invest significant dollars into these products in order to get the protection because of the perceived investment return give-up relative to equity investments.

During the last two decades, there has been a significant reduction in the number of future retirees who are covered by a company “defined benefit” pension plans. Many plans have been converted to “defined contribution” plans whereby nothing is promised at retirement; rather, some known amount of funds are invested today as per the employee's asset allocation choices. Typically, defined benefit pension plans promise to pay former employees a fixed annuity for the rest of their lives once they have retired. The shift into defined contribution means that individual investors are more responsible than ever for planning and preparing for their own retirement income needs. The reduction in defined benefit plans means that more people need to plan for and be concerned about income-for-life or outliving their financial resources.

Governments of the world's major economies continue to look for ways to reduce their financial obligations. An example is the change in retirement age that is now being phased in under the Canada Pension Plan. The age of 65 is being increased to 70 to help keep costs down over time. This will result in more pressure on retirees to fund their own retirement income needs.

A variety of private mechanisms have been developed in response to the need to provide for protection against an elderly person outliving their financial assets:
(1) Fixed Immediate Annuities. In Canada, the United States of America and other major economies, immediate annuity products are presently available. These annuities include options to receive various combinations of fixed and life contingent income payments. Contingent payments are only paid if the Insured is alive on the date each payment is scheduled to be made but are guaranteed to continue as long as the Insured is alive. Many types of financial institutions, not just insurance companies, offer immediate annuity retirement income products with payments that do not depend on death or survival. In Canada for example, banks, insurance companies, credit unions and others sell a Registered Retirement Income Fund (RRIF). In most countries, life contingent products are only allowed to be sold by life insurance companies. These life contingent products do include a form of longevity insurance protection. However, these products only offer the protection by bundling it in a payment stream that starts immediately (usually within a year), is paid annually or more frequently and continues for the Insured's lifetime. Also, the investment return implicit with these products is a low fixed rate of return as nearly all insurance companies price the products under the assumption of bond-type investment returns.
(2) Deferred Annuities. These products are available in fixed rate and variable rate forms. Essentially they are savings or accumulation products that are called annuities because they include the option to convert the accumulated account value at retirement into an immediate annuity. The form of the immediate annuity offered is no different than the products described in (1) above. These products offer no additional forms of longevity insurance protection.
(3) Variable payout annuities. In recent years, in response to investors' preference to select their own asset allocation, variable immediate annuity products have been introduced. These products offer the same types of life contingent payment options as immediate annuities. They are potentially more attractive than immediate annuities as the longevity insurance protection is not bundled with a low fixed rate of return. Higher returns through equity investing are possible. The form of longevity protection, however, is the same as immediate annuities, that being a continuing stream of annual or more frequent payments while alive.
(4) Life Insurance and Endowment Products. These products are offered in many different forms. Generally, some fixed or variable death benefit is paid upon the death of a specific person. The product may or may not bundle a savings component with related cash values. Term insurance generally has lower premiums but offers no or limited cash values and is used primarily to provide protection against premature death. Whole life or permanent insurance offers the same death protection but also includes a savings component with access to cash values should the policy owner decide to terminate coverage prior to death. Universal life is a flexible, unbundled product that can be used as either term insurance or whole life. An endowment whole life policy is one whose cash value is equal to the death benefit at some maturity age. Effectively with an endowment policy, the savings portion of the policy eventually grows so large that the policy pays the same benefit whether the person lives or dies. What is common to all of these insurance products is that they protect against early death. For those insureds that die prematurely, the death benefit relative to the premiums paid equates to a rate of return that is well in excess of that available on non-insurance investments. For those that live a long life, the opposite is true. There is in effect a subsidy paid by those that survive to those that die prematurely. Obviously, these products offer little or no longevity insurance protection.
(5) Structured Settlements. These products typically make payments related to the settlement of a personal injury lawsuit or claim where all or part of the settlement calls for future periodic payments. These periodic payments are usually funded through an annuity purchased from a life insurance company. Structured settlements are designed to provide an ongoing income stream for the injured party as well as providing future lump sums to cover medical or educational expenses. As a component of the settlement, there may be payments that are paid as a lump sum, contingent on the survival of the insured to that date. These payments are offered only part of the overall settlement income stream, however, not on a stand-alone basis. In addition the injured party could be of any age and is typically not concerned about living well beyond a normal retirement age. Furthermore, in most countries, these products are structured to comply with very specific local structured settlement tax regulations such that the beneficiary receives the benefits on a favorable tax basis.
(6) Long Term Care. This is insurance that helps you pay for long term care services, such as home care or care in a nursing home or an assisted living facility. Typically, little or nothing is paid if you simply survive. You must incur expenses related to care and illness to claim any benefits. This product addresses a serious need and is related to longevity insurance but it does not address the basic protection that the elderly have in regards to outliving their income, whether they need care or not.

There is a need for additional insurance options that expressly provide protection against the risk of a longer than expected lifetime.

### SUMMARY OF THE INVENTION

To overcome the deficiencies of convention products and methods, an object of the present invention is to provide a computer based method and system for determining financing of a longer than expected lifetime. This longevity insurance protection will typically be purchased by persons over the age of 55 and will be purchased by paying an insurance company a single premium or a limited number of annual premiums.

In return for the premium(s), the insurer agrees to pay a certain schedule of benefits. The main benefit and attraction of the insurance is that the insurer agrees to pay a lump sum survival benefit amount if and only if the insured survives to the “target age.” The target age will be selected by the customer and will normally be within normal life expectancy. For example, if the insured is 65 at issue, the target might be set at age 80.

The surviving insured may then use the proceeds of the insurance to fund his or her financial needs beyond the target age. The advantage of providing a lump sum at the target age is the flexibility to plan at that time whatever needs have arisen. It is difficult to plan in advance the form of the need (income, medical, home improvement, estate giving).

Another advantage of this product for the insured is that by knowing with certainty the amount of funds that will be available should they survive to the target age, they can feel much more comfortable about using and spending the balance of their financial assets before the target age. In addition, the presence of the insurance protection may make the insured more comfortable with taking additional investment risk and potentially earning higher returns on those financial assets that are not used to purchase the longevity insurance protection.

In addition to the lump sum survival benefit, some death benefits may or may not be included; for example, a return of 50% of the premium upon death. This is not a required feature of the product but may be added, especially in the first 2 or 3 years after issue when customers may be concerned that they get nothing if death occurs quickly.

The “policyholder” or “customer” is the person that pays the premiums and owns the policy. The “insured” is the person whose death or survival determines the benefits payable under the policy. The “survival-beneficiary” is the person designated to receive the survivor benefits under the policy. If death benefits are offered, there will also be a “death-beneficiary.” Normally the policyholder, insured and survival-beneficiary will be the same person. Others may purchase the product, however, such as the insured's children who may be more concerned about a parent living a long life.

It may be desired (but not necessary) that the product qualify as a life insurance policy for tax purposes as described further below. The benefit of doing this is that the survival benefit might be considered as a death benefit and received tax-free by the survivor-beneficiary. In many countries, in order for the survival benefits to be treated as death benefits for tax purposes, it may be necessary to include another insured life whose death is used to trigger payment of the survival benefit. In this case, there will also be another insured or group of insureds. These additional “death-insureds” will be older people, mostly over age 90, who have a relationship to the policy owner that creates an insurable interest and who have agreed to be insureds under the policy and whose lives are used to create a death benefit. In effect, the survival benefit is only paid at the target age to the survival-beneficiary if one of the death-insureds has died and the insured is still alive. In the remote chance that all of the death-insureds are still alive at the target age, the survival benefit will be paid as soon as one of the death-insureds dies.

Regardless of whether the survival benefit qualifies as a death benefit for tax purposes, the longevity insurance will be an attractive financial proposition for those that survive. This stems from the fact that, by paying nothing or very little where an insured dies before the target age, the insurance company is able to pay much higher amounts to those that do survive. This can be referred to as a “death-subsidized” product. Normally, the insurer will invest the premiums that it receives in high quality fixed income securities. By adding the death subsidies (and interest thereon) to the interest received on the premiums, the insurer is able to guarantee survival benefits that, when expressed as an interest rate or yield, are very high relative to other fixed rate products. For example, where the target age is 15 years after issue, the survival benefit that is offered, or quoted, might be a 10% yield per annum.

A further object of the present invention is to make longevity insurance more flexible, available and affordable by providing a method that guarantees a lump sum payment to a beneficiary should the insured life survive to a certain target date to protect against the risk of a longer than expected lifetime.

Another object of the invention is to make available a financial planning tool that provides a known lump sum survival benefit that is not linked to an ongoing annual or more frequent payment stream.

Yet another object of the invention is to provide a more flexible financial planning tool to enable the elderly, their families and other interested parties to more appropriately plan for retirement income needs both before and after a normal life expectancy.

Still another object of the invention is to provide details of a specific plan structure that will potentially create favorable tax effects of receiving survival benefits.

The foregoing objects are realized in a computer based method and system for a financial institution such as a life insurance company to provide insurance protection to compensate an interested party against the financial risk that an elderly person (the “Insured”) lives a longer than expected lifetime. Broadly, the computer based method comprises: determining the date upon which any survival benefits will be paid; determining the lump sum survival benefit that will be payable at the future date should the Insured survive; determining the death benefits, if any, that would be payable should the Insured die prior to receiving the survival benefits; determining the single premium or limited number of premiums that are to be paid to purchase the insurance protection; inputting an application and creating legal contractual status with a policy owner for the insurance plan; determining premium payments to be received from the policy owner as per the terms of the contract; and disbursing death and survival benefits as per the terms of the contract.

The exemplary method may also comprise determining the financial resources and needs of the Insured and any potential retirement income shortfall should the Insured live a longer than expected lifetime. Such information may be useful for determining a required amount of a survival benefit. Further, the method may comprise determining the life expectancy of the Insured which information may be useful for determining the desired date upon which any survival benefit will be paid. Additionally, a step of determining the possible tax consequences of the payment of any death and survival benefits and making modifications to the premiums or benefits so as to optimize the local country tax effects may be performed.

The method of the present invention uses a number of data inputs and actuarial methods that allow a financial institution to establish a price to charge for the longevity insurance coverage. The computer based system and method will take into account the amount of coverage requested, the premium payment pattern, the life expectancy of the insured, expected investment return on invested assets, expenses, profit and cost of capital charges.

The processes for the method may be stored in a carrier containing a computer program for use in a computer system having a display. According to one aspect of the present invention, the computer program includes means for determining a target survival date for the insured; means for determining a survival benefit for the insured; means for determining a premium to be received in exchange for payment of the survival benefit to a beneficiary upon survival of the insured to the target survival date.

According to one aspect of the present invention, the carrier is one of a CD-ROM, a floppy disk, a Zip cartridge, a magnetic media, an optical wave, and a carrier wave.

It is contemplated that a financial institution will continuously offer this longevity insurance coverage to persons of various ages and sexes and each policy will have its own schedule of premium payments and survival and death benefits. The premium payments for all policyholders that purchase the longevity insurance product may be invested as a whole by the financial institution. The financial institution will use its own investment strategies to balance risk and reward, achieve its profit objectives and to ensure that it will be able to make timely benefit payments as per the term of the policies sold.

### BRIEF DESCRIPTION OF THE DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following Figures:

FIGS. 1A-1B illustrate a flow chart of an exemplary embodiment of the present invention.

### DETAILED DESCRIPTION OF THE INVENTION

The method described herein contemplates that an insurance provider or insurer, such as a life insurance company, implements a program whereby longevity insurance policies will be sold on an ongoing basis to different policy owners. Under each policy a policy owner will make predetermined premium payments to the insurance company over a period of time in exchange for the insurance company paying predetermined lump sum survival benefits at a predetermined future date (target date) to the policy's survival beneficiary if the policy's survival insured is still alive on the target date. It is expected, though not required, that the policy owner, survival-insured and survival beneficiary all be the same person as normally the product will be purchased by elderly persons who wish to protect themselves against the risk of longer than expected lifetime. Alternatively, the interested party may be a child of the elderly person who would be the policy owner and who would pay the premiums.

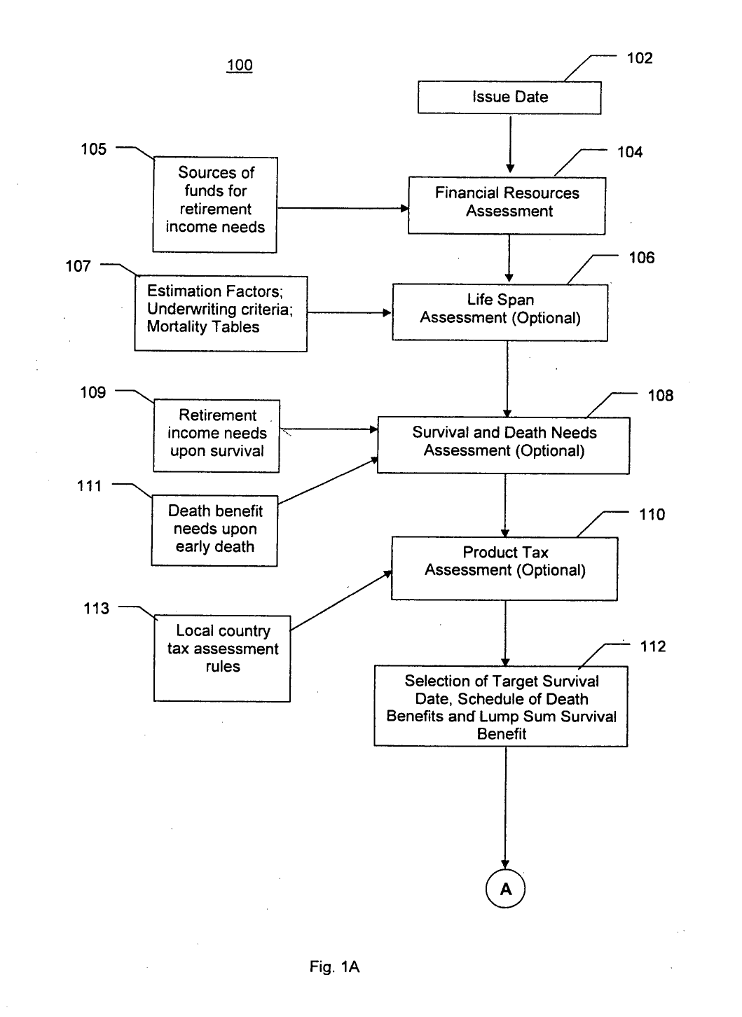

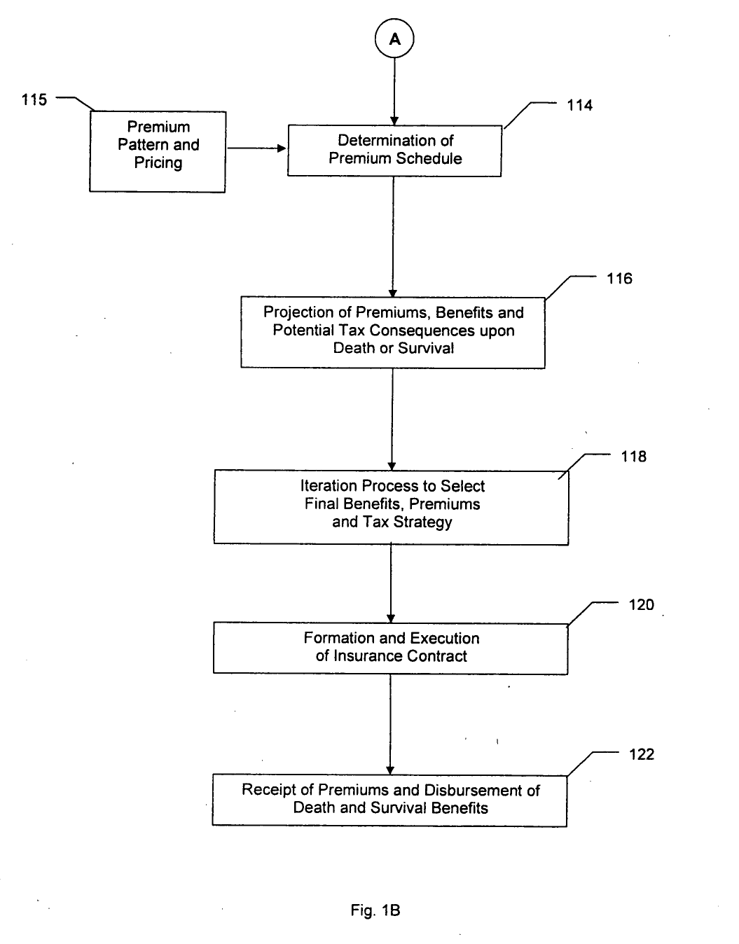

Referring now to FIGS. 1A-1B a flowchart 100 of an exemplary embodiment of the present invention is illustrated.

At Step 102, the issue date is used as an input to a computer though a man-machine interface such as a keyboard for example. This is the date on which the contract is expected to come into legal force. The first premium would normally be paid on this date and the price of the insurance benefits would be determined based on this date.

Next, optionally at Step 104, the assessment of the insured's financial resources is performed. This is a recommend component of the process, but not a required step if the desired amount of coverage is known by the policyholder. In this step, sources of income to fund retirement needs 105, and their likely amounts including, but not limited to, employment income, retirement pensions provided by government programs as well as current and former employers, the insured's tax-sheltered and other accumulated savings, real estate and other real property, inheritances, support from children and other interested parties, are identified and used as an input for this step. In some cases it may be necessary to make certain assumptions about the annual rates of investment return and capital appreciation on certain assets as well as some order of liquidation; the output of this process will be a projection of annual income during retirement.

Next, optionally at Step 106, a Life span assessment is performed to estimate the insured's life expectancy. This is yet another recommended but optional step in the exemplary process. Traditional life insurance underwriting criteria and actuarial mortality tables 107 can be used as inputs to this step. Factors taken into account may include the insured's age at issue, sex, occupation, population mortality experience, insurance and annuity buyers mortality experience, expected rates of futures mortality improvements, family medical history, the insured's own medical history and current sense of well being reflecting lifestyle and socio-economic status such as access to healthcare. An underwriter would analyze all of these factors to determine an expected lifespan or life expectancy of the insured.

Next, optionally at Step 108, an assessment of survival needs is performed. This is still another recommended but optional step in the exemplary process. This step includes an analysis of inputs 109 including the inflation-adjusted cost of living (food, shelter, transportation) assuming good health together with some provision for medical expenses including in-home or nursing home care, prescriptions, etc. This step may also include an assessment of needs upon death based on inputs 111, such as funeral expenses, expenses for surviving spouse and bequests to heirs and charities, for example.

Next, at Step 110 a tax assessment is performed based on inputs 113. This step involves an optional examination of the taxation rules 110 of the country to determine the optimal way to structure the product. Rules 110 may include for example:
Treatment as stand-alone product;
Assessment of advantages and criteria to obtain tax deferral on interest portion by structuring as life insurance or annuity contract;
Assessment of criteria and advantages to qualify survival benefit as a death benefit;
Tax treatment of loss upon early death; and/or
Eligibility rules for investments made with tax-sheltered funds.

In some jurisdictions it may be possible to have the survival benefit treated as a death benefit and potentially received tax-free by the beneficiary. Tax considerations may also influence the pattern of premium payments. For example, both the US and Canada include restrictions on single premiums for policies that wish to comply as life insurance policies for tax purposes.

At Step 112, and as a result of the preceding analysis, it will be possible to identify any shortfall in projected retirement income particularly at older ages. The analysis would also reflect the impact on retirement income during the pre-target date years, of using financial assets to purchase the insurance policy. As a result, the policy owner will be able to identify a desired survival benefit and target survival date and will want to know the premium(s) required to fund this protection. The desired survival benefit and target date will be established to provide for all or some portion of the projected present value of retirement income shortfall after the target date. Alternatively, the policy owner may know the amount of funds available to purchase the insurance policy and he or she wants to know the amount of survival benefits that can be purchased. The policy owner may also desire that some limited amount of death benefits be paid, especially during the first couple of years should the insured die prematurely. These death benefits could be something like 100% of premium in year one, 50% in year two and nothing if death occurs after the second year.

Once the desired survival benefits and target survival date are known, at Step 114 the premium schedule is determined based on inputs 115 and provided as either a hard copy output and/or displayed on the computer system's display. Exemplary inputs 115 may include i) Actuarial probability of death benefits and survival benefit, ii) Single premium or limited payment schedule due to tax strategy, iii) Expected net return on invested assets, iv) Expenses including selling commissions, insurance administration and investment management and/or v) Financial institution profit charge resulting from business investment and risks as well as cost of capital and pricing hurdle rate

At Step 116, premiums are projected as well as the determination of benefits and potential tax consequences. At Step 118, an iterative process is performed to select final benefits, premiums and tax strategies. At Step 120, the insurance contract is formulated and executed. Finally at Step 122, premiums are received and ultimately the death and survival benefits are disbursed as appropriate.

The following example illustrates the typical steps involved in the exemplary process:
a) This illustrative example involves a 70 year old male purchasing an insurance policy on Jul. 1, 2003 that will provide a $50,000 survival benefit should he survive to 15 years and be alive on Jul. 1, 2018.
b) Based on the underwriting process, the actuary selects the following annualized rates of mortality including any projections of mortality improvement: 0.0212, 0.0231, 0.0253, 0.0278, 0.0305, 0.0338, 0.0371, 0.0412, 0.0456, 0.0507, 0.0565, 0.0635, 0.0714, 0.0789, 0.0885, 0.0976 for years 1, 2, 3 etc. these annual rates are referred to as q70, q71, q72, . . . , q83, q84.
c) The probability of surviving 15 years is determined using standard actuarial techniques as (1-q70)×(1-q71)× . . . ×(1-q83)×(1-q84) which in this case works out to be a 48.9% probability.
d) The potential survival benefit of $50,000 and the 48.91% survival probability are used to determine that the expected survival benefit is $24,455.00.
e) Assuming that the assets purchased with the net premium payment will be invested to earn a net return of 6% per annum (after provisions for investment risks and expenses), the present value of the expected survival benefit is determined to be $10,204.22=$24,455.00×(1.06A-15).
f) The insurance company will normally increase the price to provide a return on its capital and to compensate it for taking the risk that survival probabilities are wrong. In practice this can be measured in many different ways. For this example, assume that the insurer will add a 10% loading to the premium or $1,020.42 in this case for profit and cost of capital.
g) If the up front commission to be paid to agents and other distributors is 5%, then the additional loading for commissions in this example is $590.77=(10, 204.22+1020.42)/(1-0.05).
h) Hence, the total single premium to be paid on Jul. 1, 2003 by the 70 year old to purchase this insurance coverage is $11,815.41=$10,204.22+$1,020.42+$590.77.
i) For each policy where the Insured does survive 15 years to the target date, the return on investment from the insurance plan will be 10.1% per annum in the present example.

The present invention contemplates that the insurance company will collect premium payments from policyholders and invest in a manner that it deems appropriate. The premium payments need not be kept in separate fund accounts for each policy owner and there need not be any individual accounting for each policy owner other than to keep track of each policy's premium payments to ensure that schedule premiums are being paid. The manner in which the insurance company invests the assets relating to the premium payments is not an aspect of the present invention and it is contemplated that the insurance company may employ any investment management techniques that it deems appropriate but would normally involve a prudent balance of risk and reward, would allow the insurer to achieve its profit and return on capital objectives and would ensure that future benefit payment to beneficiaries will be funded.

The insurance company will continue to sell the insurance coverage to new policy owners whose premium payments will be added to the insurers general account. At some point the insurance company will begin making death and survival benefit payments that will be funded by the accumulated assets of the insurer's general account.

### Optimizing the Tax Treatment

In most countries, death benefits received under insurance policies are received tax-free by the beneficiary. With the insurance protection contemplated by the present invention, it is likely that the survival benefits themselves will not constitute a death benefit because the payment is related to survival not death. It would be desirable that the survival benefits be treated as tax-free death benefits as this would considerably enhance the amount of retirement income available if the insured lives a longer than expected lifetime.

Because the present invention is new, most countries tax regimes do not contemplate such a product and hence it may be necessary for some number of years to optimize the product by adding or modifying premiums and benefits so as to create the most tax-advantageous structure. It is likely that as these products become popular, the various tax systems will respond to create appropriate incentives and fairly treat these products.

One variation that will be possible in the structuring and pricing of the present invention is to add another insured life to the insurance policy whose death will be used to trigger the payment of the survival benefits. This extra life or lives will be referred to as the “death-insured.” Ideally, a death-insured will be a person that is very elderly (for example over 90 years of age) and who has an “insurable interest” relationship to the policy owner. Most jurisdictions frown on the use of life insurance policies to wager on people's lives and normally require that the policy owner have an insurable interest in the insured life. Typically, this means that the policy owner has more to lose than gain, emotionally or financially, as a result of the death of the insured.

If this insurable interest is present, the longevity insurance plan can be modified to state that survival benefits will only be paid on the target date if the death-insured is no longer alive and the insured is still alive. In this case, it may be possible to classify the survival benefit as death benefits for tax purposes because a necessary condition is the death of the death-insured. Also, it would normally be desirable to have the death-insured be a fairly elderly person, over 80 for example, to ensure a high probability of death prior to the target date.

A further tax consideration is that most countries require that life insurance policies involve premium payments that are not excessive in relationship to the death benefits. For example, both Canada and the United States have tests that measure this relationship and policies must comply to receive favorable tax treatment of any death benefits. With respect to the present invention, these tax compliance requirements should preferably be taken into account in setting the premium payment pattern and the target date.

Unique Features of the Present Invention:

a) it offers a lump sum life contingent payment on a stand-alone basis; there is no requirement that payment be bundled with other benefits;

b) it is sold to a segment of the population that has a need to protect against the risk that they have an extended life span (beyond normal life expectancy at or around retirement) and may outlive their financial resources; immediate annuities are the only other form of protection of this nature; the difference with this product is that the longevity protection is not bundled into a series of payments that start immediately and continue for the rest of one's life; this product measures survivorship at one future point in time only and pays out as a lump sum; the survivor may structure the use of the resulting payout any way he or she desires;

c) there is specifically a death subsidization of the survival benefits; in other words, the product pays only limited benefits in the event of death prior to the survival age (something less than the premium plus interest) in order to pay enhanced benefits to those that do survive; this death subsidization is not present in life insurance policies at all and, again, only indirectly in immediate annuities and only by continually surviving and receiving benefits; and

d) methods are introduced to optimize the tax treatment of the benefits; this optimization is not a necessary feature of the product but may considerably enhance its appeal; the tax structures are very country specific and each case may involve some tax risk where regulations are not completely clear.

In another exemplary embodiment, the product may be created through a Separate Account Guarantee (referred to herein as a Guaranteed Minimum Survival Benefit, GMSB).

For some period of time, the above described survival insurance method and product will be new in many countries. During this time it is likely that applicable laws and regulations that are applied will be the same as those applied to traditional payout annuities. In this case, it is likely that certain insurance company cash surrender value (called non-forfeiture rules in the United States) regulations will need to be considered in the business method. In jurisdictions with these types of regulations, the funding of survival benefits is undermined by the requirement to offer cash values to those dying or wishing to terminate their contracts prior to the target survival date. In such cases, the following modifications to the exemplary process could be applied. These modifications could also be applied to an assortment of other guaranteed minimums that are typically offered with separate account value products.
A variable separate account structure is used whereby the account value is based on the number of units owned and the value per unit; this may require complying with securities regulations in addition to insurance regulations.
The separate account product will offer a guaranteed minimum survival benefit (GMSB) that is exactly the same as that outlined in this document—a target survival date is selected and should the insured survive to that date, the survival benefit is paid. This survival benefit would typically, but not necessarily, be based on an established formula such as the premiums paid accumulated at a specific fixed rate of interest or it could be the single premiums accumulated based on the total return or price return or variations thereof of common market indices such as the S&P500 or Lehman Aggregate Index, for example.
The separate account investment strategy will be to invest in money market instruments such as T-Bills and Commercial Paper, for example.
The annual fees charged to the fund will be as high as allowed under the applicable regulations and could vary with the level of interest rates themselves.
The surrender charges will be as high as allowed under the applicable regulations.
The surrender charges would apply to all distributions from the fund including death, except they would not apply in the event that the proceeds are withdrawn after the target survival date and if the survival benefit is paid, i.e. they do not apply to the survival benefits paid.
The survival benefit is paid as a top up to the account value based on the specified formula if the conditions are met.
The funding of the guarantee or survival benefit is accomplished through the insurer's general account through the use of interest swaps and other financial derivatives. For example, the annual fees received from the fund represent receiving a floating cash flow stream tied to short term interest rates and would allow the insurer to enter into a pay float, receive fixed swap where the term of the swap would allow the insurer to lock in a fixed rate of interest appropriate to the duration of the survival benefits potentially payable. The same principles could be applied to using total return swaps where the insurer would enter a swap to pay London InterBank Offered Rate (LIBOR) and receive the return of the S&P500. This approach would be used to fund a survival benefit whose pay-off was a function of the return in the equity markets. Similar techniques can be used with credit default swaps to add credit risk to the fixed rate of return.
This same separate account technique of investing the separate account in floating instruments and funding the guarantees through the general account with derivatives could also be used for other minimum guarantees such as death benefits, income benefits and accumulation benefits.

The effect of this modification to the method is that the cash values paid are minimized for those terminating or dying prior to the target survival date. This will significantly enhance the ability to offer more substantial survival benefits to those that do survive.

The computer program for implementing the exemplary embodiments of the present invention may be contained on a carrier such as a CD-ROM, a floppy disk, a Zip cartridge, a magnetic media, an optical wave, and a carrier wave. The program may either be transferred into resident memory of the computer as required or hosted remotely and accessed by the user in a ASP environment.

Although the invention is illustrated and described herein with reference to specific embodiments, the invention is not intended to be limited to the details shown. Rather, various modifications may be made in the details within the scope and range of equivalents of the claims and without departing from the invention.

1. A method for use with a computer for determining at least a portion of the financing of a longer than expected life of an insured, the method comprising the steps of:
determining a target survival date for the insured;
determining a survival benefit;
determining a premium to be received in exchange for payment of the survival benefit to a survival-beneficiary upon survival of the insured to the target survival date; and
determining a payment of a survival benefit to the survival-beneficiary based on the insured surviving to the target survival date.

2. The method according to claim 1, further comprising the step of:
paying a death benefit to a death-beneficiary based on the insured dying before the target survival date.

3. The method according to claim 2, further comprising the step of determining the death benefit based on an amount of the premium plus interest.

4. The method according to claim 1, wherein the step of determining a target survival date comprises determining a life expectancy for the insured and choosing a target survival date based on the determined life expectancy.

5. The method according to claim 1, wherein the step of determining the survival benefit comprises the step of:
performing at least one of i) assessing survival needs, ii) assessing tax consequences and iii) assessing retirement income availability, based on the insured living to the target survival date; and
determining the survival benefit based on the result of the at least one assessment.

6. The method according to claim 5, further comprising the step of determining the premium in accordance with the determined survival benefit.

7. The method according to claim 5, wherein the survival benefit is further determined in accordance with a tax planning strategy that is selected to minimize tax liability to the survival benefit beneficiary.

8. The method according to claim 1, wherein at least one of the premium and the survival benefits are determined in accordance with an estimate of a death subsidization available from the premiums received in relation to other insureds.

9. The method according to claim 1, further comprising the step of determining a premium and wherein the step of determining the survival benefit comprises choosing the survival benefit in accordance with the affordable premium.

10. The method according to claim 1, wherein the survival benefits are offered through a separate account to minimize cash values to those withdrawing or not surviving to the target date comprising the steps of:
investing the separate account assets in at least short-term securities;
paying at least one of management and guarantee fees from the separate account to the insurer's general account and charging surrender charges for distributions other than those related to survival;
paying the survival benefits to the separate account holder in the form of an account value top-up;
waiving withdrawal charges if proceeds are withdrawn after the target date as a Guaranteed Minimum Survival Benefit (GMSB); and
using derivatives in the insurer's general account to fund the separate account guarantees.

11. An insurance product in accordance with claim 1.

12. The method according to claim 1, wherein the survival-beneficiary is the insured.

13. The method according to claim 1, wherein the survival benefit is treated as a tax-free benefit death benefit.

14. A method for use with a computer for determining at least a partially financing of a longer than expected life of an insured, the method comprising the steps of:
determining a target survival date for the insured;
determining a survival benefit for the insured;
determining a premium to be received in exchange for payment of the survival benefit to a beneficiary upon survival of the insured to the target survival date.

15. The method according to claim 14, further comprising the step of paying the survival benefit to the beneficiary based on the insured surviving to the target survival date.

16. The method according to claim 14, further comprising the step of paying the survival benefit to the beneficiary based on a further insured surviving to the target survival date.

17. The method according to claim 14, wherein the survival-beneficiary is the insured.

18. The method according to claim 14, further comprising the step of paying a death benefit to a death-beneficiary based on the insured dying before the target survival date.

19. A computer based method for providing an insurance plan for insuring a longer than expected life of an insured, the method comprising the steps of:
a) determining at least one of financial resources, needs and retirement income shortfalls based on the insured living beyond a predetermined date in the future;
b) determining a life expectancy of the insured;
c) determining a date upon which any survival benefits will be paid;
d) determining a lump sum survival benefit payable at the future date should the insured survive beyond the predetermined date;
e) determining death benefits, if any, be payable should the insured die prior to the predetermined date;
f) determining one of a single insurance premium and plurality of insurance premiums for the insurance plan;
g) determining tax consequences of the payment of any death and/or survival benefits;
h) adjusting at least one of the premiums and benefits based on any local country tax criteria; and
i) disbursing at least one of death and survival benefits as per the contract.

20. The method in accordance with claim 19, wherein step f) further comprises the steps of:
f1) receiving an application and creating a contract with a policy owner for the insurance plan; and
f2) receiving premium payments from the policy owner as per the terms of the contract.

21. A computer system for determining financing of a longer than expected life of an insured, the computer system comprising:
means for determining a target survival date for the insured;
means for determining a survival benefit;
means for determining a premium to be received in exchange for payment of the survival benefit to a survival-beneficiary upon survival of the insured to the target survival date; and
means for determining a payment of a survival benefit to the survival-beneficiary based on the insured surviving to the target survival date.

22. A computer-readable medium for use in a computer system having a display and including a user defined database management system or spread sheet which stores data, said computer readable medium being encoded with a computer program for managing a plurality of data which define attributes of an insured, the data including at least one of the group consisting of an insured's age at issue, sex, occupation, population mortality experience, insurance and annuity buyers mortality experience, expected rates of futures mortality improvements, family medical history, and/or the insured's own medical history, the computer-readable medium comprising:
means for causing the computer determine a target survival date for the insured;
means for causing the computer to determine a survival benefit;
means for causing the computer to determine a premium to be received in exchange for payment of the survival benefit to a survival-beneficiary upon survival of the insured to the target survival date; and
means for causing the computer to determine a payment of a survival benefit to the survival-beneficiary based on the insured surviving to the target survival date.

23. A carrier containing a computer program for use in a computer system having a display, said computer program including:
means for determining a target survival date for the insured;
means for determining a survival benefit for the insured; and
means for determining a premium to be received in exchange for payment of the survival benefit to a beneficiary upon survival of the insured to the target survival date.

24. The carrier according to claim 23, wherein the carrier is one of a CD-ROM, a floppy disk, a Zip cartridge, a magnetic media, an optical wave, and a carrier wave.
